(19) United States
(12) Patent Application Publication
(10) Pub. No.: US 2026/0051783 A1
(43) Pub. Date: Feb. 19, 2026

(54) SELF-CONNECTING GENERATOR TERMINAL BLOCKS

(71) Applicant: Hamilton Sundstrand Corporation, Charlotte, NC (US)

(72) Inventors: Aaron M. Finke, Janesville, WI (US); Eric A. Carter, Monroe, WI (US)

(21) Appl. No.: 18/808,918

(22) Filed: Aug. 19, 2024

(51) Int. Cl. H02K 5/22; F01D 15/10; F01D 25/28; H02K 7/18

(52) U.S. Cl. CPC H02K 5/225; F01D 15/10; F01D 25/28; H02K 7/1823; F05D 2260/30

(57) ABSTRACT

A generator includes a stator housing, a stator assembly, and a terminal block. The stator housing is configured for insertion into a frame of a gas turbine engine. The stator assembly is positioned within the stator housing and configured to generate electricity. The terminal block assembly is positioned on an external surface of the stator housing. The terminal block assembly includes multiple terminal pins, and the terminal pins are aligned with terminal sockets in the frame of the gas turbine engine.

### TECHNICAL FIELD

This disclosure relates generally to gas turbine engines. More specifically, this disclosure relates to self-connecting generator terminal blocks.

### BACKGROUND

Generator terminal blocks currently use feeder lugs to connect electrical lines to the terminal blocks. This arrangement requires extra components, including terminal nuts, a cover, screws, and washers. This arrangement also leaves the connections exposed to the environment, such as rain, salt water, ice, dirt, etc. Feeder damage can occur due to rubbing on the generator or other accessories.

### SUMMARY

This disclosure provides for self-connecting generator terminal blocks.

In some examples, a generator may include a stator housing, a stator assembly, and a terminal block. The stator housing may be configured for insertion into a frame of a gas turbine engine. The stator assembly may be positioned within the stator housing and configured to generate electricity. The terminal block assembly may be positioned on an external surface of the stator housing. The terminal block assembly may include multiple terminal pins, and the terminal pins may be aligned with terminal sockets in the frame of the gas turbine engine.

Any single one or any combination of the following features may be used with the above examples. The terminal pins may extend radially from the stator assembly and axially along the external surface of the stator housing. Each of the terminal pins may have a solder cup for soldering the terminal pin to the stator assembly. Each of the terminal pins may have a threaded insert for bolting the terminal pin to the stator assembly. The generator may include an alignment pin positioned on the external surface of the stator housing, and the alignment pin may be configured to align with an alignment groove in the frame of the gas turbine engine. The stator housing may be inserted into the frame of the gas turbine engine, and the alignment pin may be inserted into the alignment groove prior to the terminal pins being inserted into the terminal sockets. The generator may include an input shaft configured to couple to a low-speed shaft of the gas turbine engine, and the input shaft may be configured to rotate one or more components of the stator assembly to generate the electricity.

In other examples, a gas turbine engine may include a frame and a generator. The frame may include a frame terminal block assembly with multiple terminal sockets. The generator may include a stator housing, a stator assembly, and a generator terminal block. The stator housing may be configured to be inserted into the frame. The stator assembly may be positioned within the stator housing and configured to generate electricity. The generator terminal block assembly may be positioned on an external surface of the stator housing. The generator terminal block assembly may include multiple terminal pins, and the terminal pins may be aligned with the terminal sockets in the frame of the gas turbine engine.

Any single one or any combination of the following features may be used with the above examples. The terminal sockets each may include a contact band configured to secure and electrically connect to the terminal pins. Each of the terminal sockets may include a feeder solder cup configured to secure and electrically connect electrical lines to transmit the electricity to one or more components of the gas turbine engine. The frame may further include a feeder conduit configured to route the electrical lines through the frame without exposure to objects flowing though the frame. The generator may include an alignment pin positioned on the external surface of the stator housing, the frame my further include an alignment groove on an internal surface, and the alignment pin may be configured to align with the alignment groove in the frame of the gas turbine engine. The stator housing may be inserted into the frame of the gas turbine engine, and the alignment pin may be inserted into the alignment groove prior to the terminal pins being inserted into the terminal sockets. The generator may include an input shaft configured to couple to a low-speed shaft of the gas turbine engine, and the input shaft may be configured to rotate one or more components of the stator assembly to generate the electricity.

In still other examples, a method may include aligning multiple terminal pins in a terminal block assembly positioned on an external surface of a stator housing with terminal sockets in a frame of a gas turbine engine. The method may also include inserting the stator housing into the frame of the gas turbine engine. The method may further include generating electricity using a stator assembly positioned within the stator housing.

Any single one or any combination of the following features may be used with the above examples. The terminal pins may extend radially from the stator assembly and axially along the external surface of the stator housing. The method may include soldering a solder cup on each of the terminal pins to the stator assembly. The method may include bolting a threaded insert on each of the terminal pins to the stator assembly. The method may include aligning an alignment pin positioned on the external surface of the stator housing with an alignment groove in the frame of the gas turbine engine. Inserting the stator housing into the frame of the gas turbine engine may include inserting the alignment pin into the alignment groove prior to the terminal pins being inserted into the terminal sockets.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIG. 1 illustrates an example self-connecting generator terminal block for a generator in accordance with this disclosure;

FIG. 2 illustrates an example stator housing assembly for a generator in accordance with this disclosure;

FIG. 3 illustrates an example cross section of a terminal block for a generator in accordance with this disclosure;

FIG. 4 illustrates an example exploded view of an assembly including a generator and a turbine engine frame in accordance with this disclosure;

FIG. 5 illustrates an example assembly including a generator and a turbine engine frame in accordance with this disclosure;

FIG. 6 illustrates an example terminal block for a turbine engine frame in accordance with this disclosure;

FIG. 7 illustrates an example cross section of a terminal block with an assembly of a generator and a turbine engine frame in accordance with this disclosure; and

FIG. 8 illustrates an example method for connecting a generator terminal block according to this disclosure.

### DETAILED DESCRIPTION

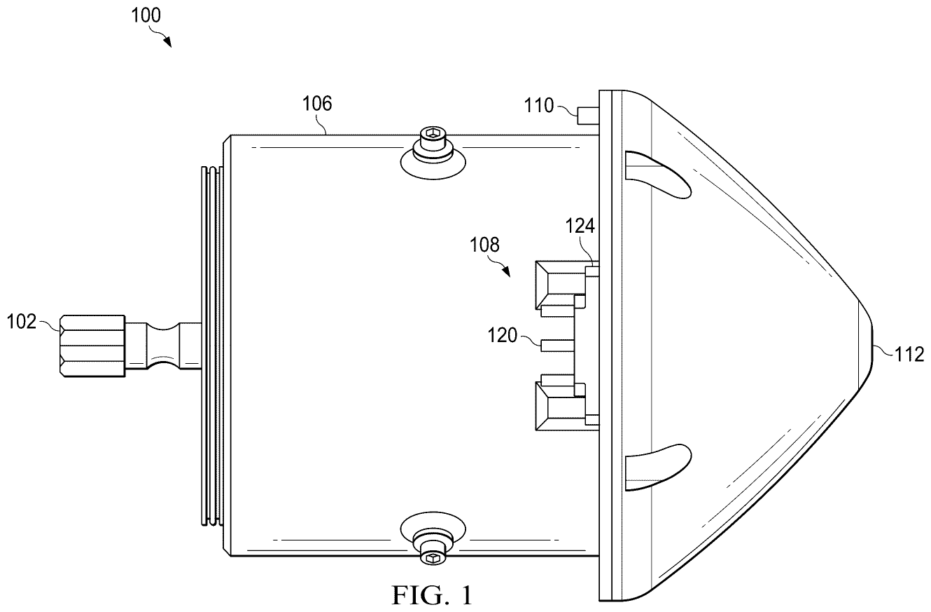

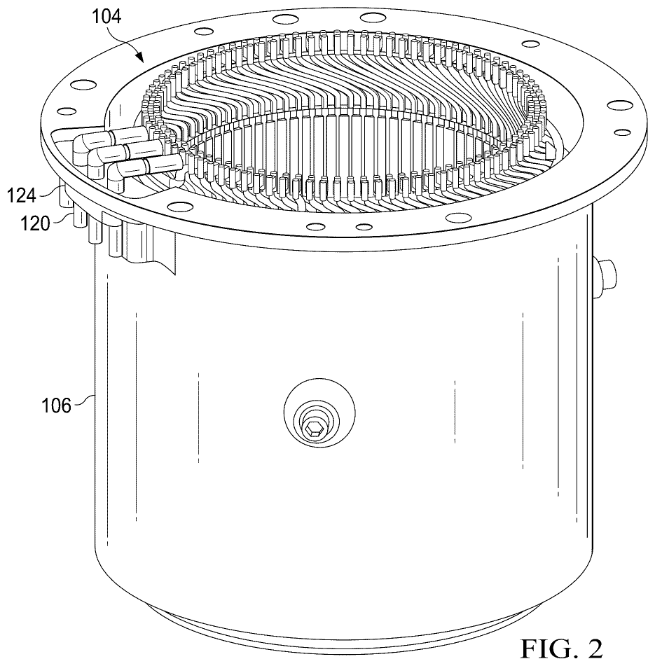

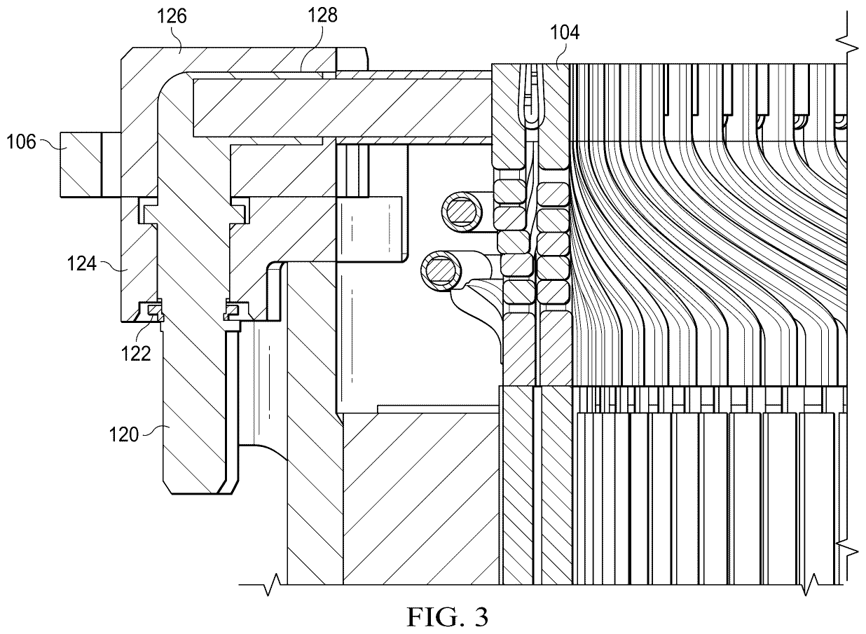

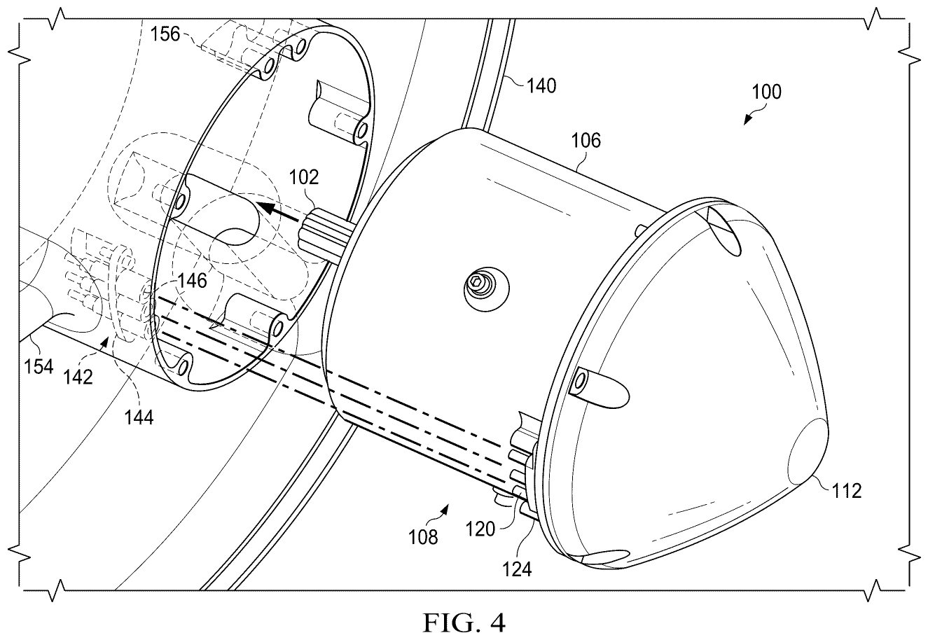

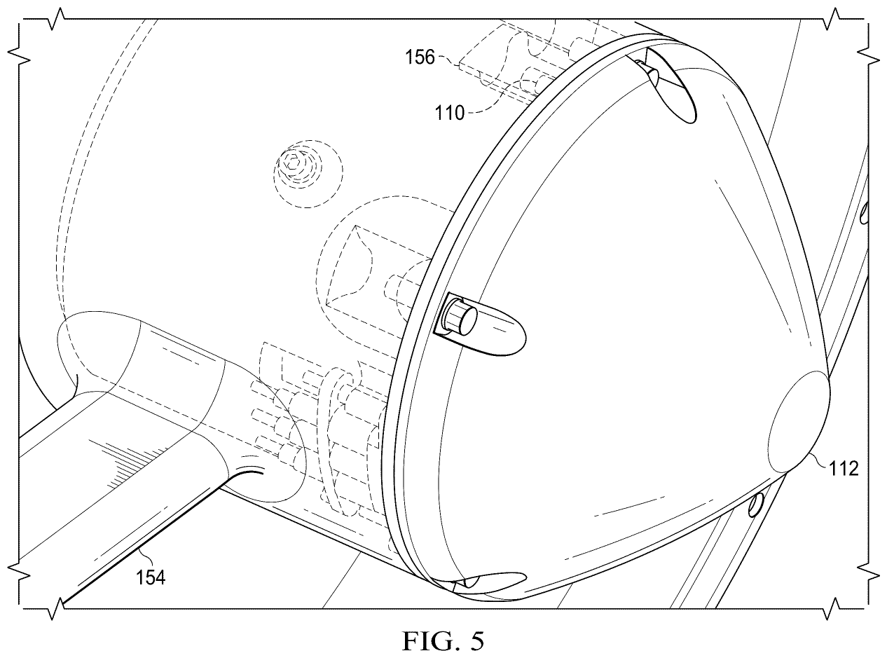

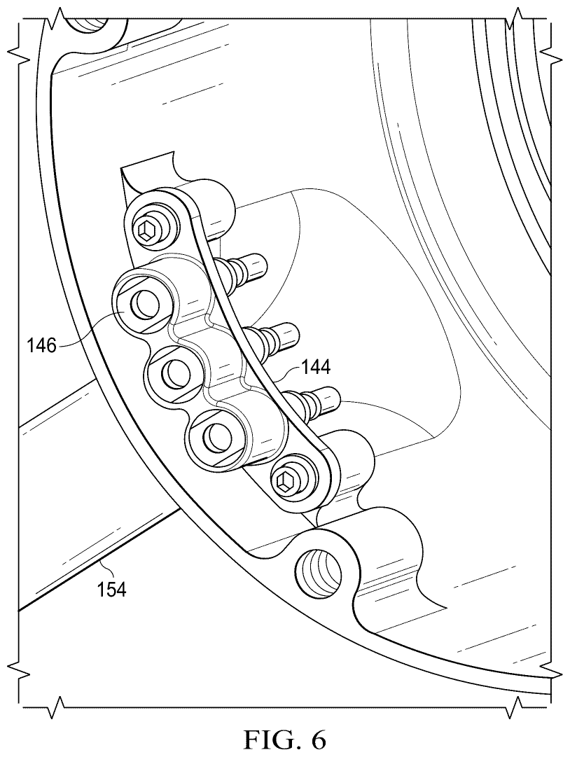

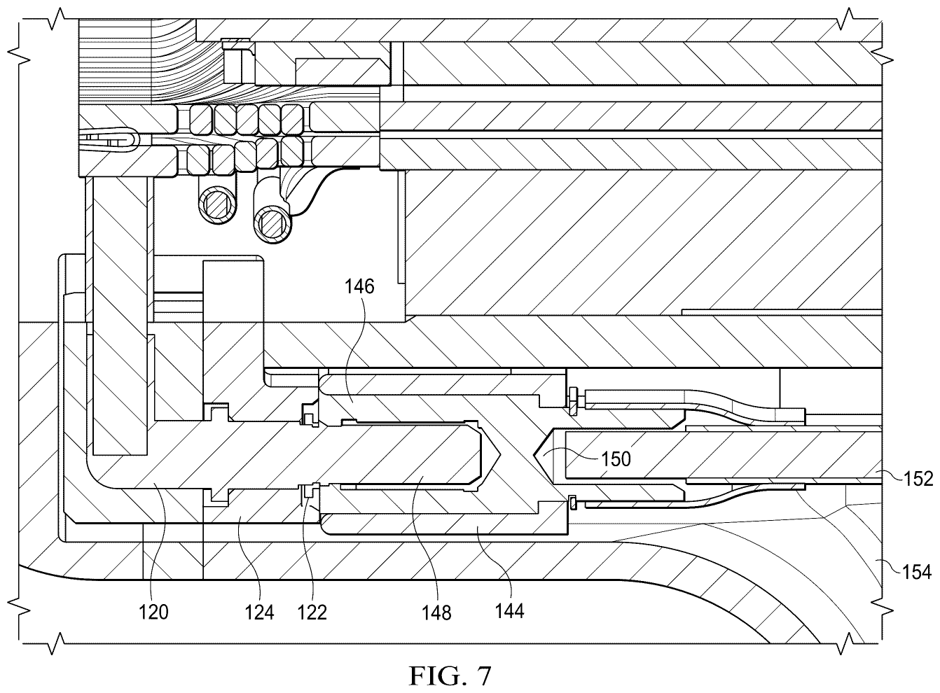

FIGS. 1 through 8, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As discussed above, generator terminal blocks currently use feeder lugs to connect electrical lines to the terminal blocks. This arrangement requires extra components, including terminal nuts, a cover, screws, and washers. This arrangement also leaves the connections exposed to the environment, such as rain, salt water, ice, dirt, etc. Feeder damage can occur due to rubbing on the generator or other accessories. This disclosure provides generators with self-connecting generator terminal blocks that secure connections to a gas turbine engine and reduce an amount of components required for the connections.

FIGS. 1 through 7 illustrate an example self-connecting generator terminal block in accordance with this disclosure. As shown in FIGS. 1 through 7, a generator 100 can be positioned at a front end of a gas turbine engine, such as a gas turbine engine for an aircraft. The generator 100 can include an input shaft 102, a stator assembly 104, a stator housing 106, a terminal block assembly 108, an alignment pin 110, and a stator cover 112. The generator 100 can be coupled to a shaft within the gas turbine engine to generate electricity for one or more other components in the aircraft.

The generator 100 can include the input shaft 102 defining a drive axis. The input shaft 102 can be engaged with a low-speed shaft or a high-speed shaft of the gas turbine engine. The low-speed or high-speed shaft can rotate the input shaft 102, which in turn rotates one or more components within the stator assembly 104 to generate electricity. The stator assembly 104 can be positioned within the stator housing 106.

The terminal block assembly 108 provides external connections for the generator 100 to output the electricity generated by the stator assembly 104. The terminal block assembly 108 can include one or more terminal pins 120, one or more retaining rings 122, an insulating terminal block 124, and an insulating cover 126. The terminal pins 120 can extend radially away from the stator assembly 104 and extend axially along stator housing 106. The terminal pins 120 can be adapted to insert into and form an electrical connection with terminal sockets 146 on the turbine engine frame 140.

The insulating terminal block 124 can include a set of terminal pin holes for the terminal pins 120 to pass through. The insulating terminal block 124 can include slots around the terminal pin holes for accommodating the retaining rings. The insulating terminal block 124 may be formed of a non-conducting material. In some cases, the insulating terminal block 124 can be connected to the stator housing 106 using screws. Also, in some cases, the terminal pins 120 can be connected to the insulating terminal block 124 using retaining rings 122. The retaining rings 122 can prevent the terminal pins 120 from sliding up or down.

The terminal pin 120 may include a connection 128 at one end for connecting to the stator assembly 104. In some embodiments, the connection 128 may represent or include a solder cup for soldering the terminal pin 120 to the stator assembly 104. In other embodiments, the connection 128 may represent or include a threaded insert for bolting the terminal pin 120 to the stator assembly 104. The insulating cover 126 may be positioned over the connection 128 to insulate the connection 128 from components outside of the terminal block assembly 108 and the stator assembly 104. The insulating cover 126 may be formed of a non-conducting material.

The generator 100 can be housed in the frame 140 of the gas turbine engine such that the terminal block assembly 108 is aligned with the terminal socket assembly 142 in the frame 140. The terminal socket assembly 142 can include an insulating terminal block 144 and multiple terminal sockets 146. The terminal sockets 146 can be equal in number to and aligned with the terminal pins 120 when the generator 100 is inserted into the frame. The terminal sockets 146 can each include a contact band 148 for securing and electrically connecting to a terminal pin 120. The terminal sockets 146 can also include a feeder solder cup 150 for securing and electrically connecting to electrical lines 152. In other embodiments, the connection 150 may represent or include a threaded insert for bolting a terminal lug to the terminal socket assembly 142. The electricity output from the terminal pins 120 can be transferred to the electrical lines 152 through the terminal sockets 146. The electrical lines 152 can be routed to one or more components of the aircraft through a feeder conduit 154. The feeder conduit 154 can extend to outside of the frame 140 to protect the electrical lines from the objects flowing through the frame.

The alignment pin 110 can be aligned with an alignment groove 156 on the frame 140. The alignment groove 156 can control an orientation of the generator 100 to be inserted into the frame 140. The alignment pin 110 can be inserted into the alignment groove 156 prior to the terminal pins 120 being inserted into the terminal sockets 146. The alignment pin 110 may protect the terminal pins 120 from damage by improper orientation of the generator 100 into the frame 140.

The stator cover 112 can be coupled to the stator housing 106. The stator cover 112 can be designed to route air around the stator housing 106. The stator cover 112 can also be made of a rugged material to protect the stator assembly 104 from any debris in the air.

Although FIGS. 1 through 7 illustrate one example of a self-connecting generator terminal block in accordance with this disclosure, various changes may be made to FIGS. 1 through 7. For example, various components in FIGS. 1 through 7 may be combined, further subdivided, replicated, omitted, or rearranged and additional components may be added according to particular needs.

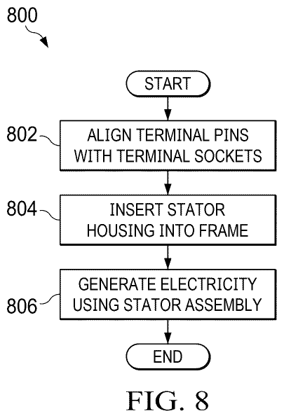

FIG. 8 illustrates an example method 800 for connecting a generator terminal block according to this disclosure. For ease of explanation, the method 800 of FIG. 8 is described as being performed using the generator 100 of FIGS. 1 through 7. However, the method 800 may be used with any other suitable system and any other suitable generator.

As shown in FIG. 8, terminal pins 120 can be aligned with terminal sockets 146 at step 802. For example, multiple terminal pins 120 in a terminal block assembly 108 can be positioned on an external surface of a stator housing 106. The terminal pins 120 can be aligned with terminal sockets 146 in a frame 140 of a gas turbine engine. The terminal pins 120 can extend radially from the stator assembly 104 and axially along the external surface of the stator housing 106. The terminal pins 120 can each include a solder cup to solder to the stator assembly 104, a crimp barrel to crimp to a wire connected to the stator assembly 104, or a male or female threaded insert to bolt to the stator assembly 104.

The stator housing 106 can be inserted into the frame 140 of the gas turbine engine at step 804. For example, an alignment pin 110 can be positioned on an external surface of the stator housing 106. The alignment pin 110 can be aligned with an alignment groove 156 in the frame 140 of the gas turbine engine. The alignment pin 110 can be inserted into the alignment groove 156 prior to the terminal pins 120 inserting into the terminal sockets 146.

The stator assembly can generate electricity at step 806. For example, the electricity can be generated using the stator assembly 104 positioned with the stator housing 106 for powering one or more components of the aircraft. The electricity can be transferred through the terminal pins 120 and the terminal sockets 146 to electrical lines 152. The electrical lines 152 can be routed to the one or more components of the gas turbine engine through feeder conduits 154.

Although FIG. 8 illustrates one example of a method 800 for connecting a generator terminal block, various changes may be made to FIG. 8. For example, while shown as a series of steps, various steps in FIG. 8 may overlap, occur in parallel, or occur any number of times.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S. C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S. C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A generator comprising:
a stator housing configured for insertion into a frame of a gas turbine engine;
a stator assembly positioned within the stator housing and configured to generate electricity; and
a terminal block assembly positioned on an external surface of the stator housing, the terminal block assembly comprising multiple terminal pins, wherein the terminal pins are aligned with terminal sockets in the frame of the gas turbine engine.

2. The generator of claim 1, wherein the terminal pins extend radially from the stator assembly and axially along the external surface of the stator housing.

3. The generator of claim 1, wherein each of the terminal pins comprises a solder cup for soldering the terminal pin to the stator assembly.

4. The generator of claim 1, wherein each of the terminal pins comprises a threaded insert for bolting the terminal pin to the stator assembly.

5. The generator of claim 1, further comprising:
an alignment pin positioned on the external surface of the stator housing, the alignment pin configured to align with an alignment groove in the frame of the gas turbine engine.

6. The generator of claim 5, wherein, when the stator housing is inserted into the frame of the gas turbine engine, the alignment pin is inserted into the alignment groove prior to the terminal pins being inserted into the terminal sockets.

7. The generator of claim 1, further comprising:
an input shaft configured to couple to a low-speed shaft of the gas turbine engine, the input shaft configured to rotate one or more components of the stator assembly to generate the electricity.

8. A gas turbine engine comprising:
a frame comprising a frame terminal block assembly with multiple terminal sockets; and
a generator comprising:
a stator housing configured to be inserted into the frame;
a stator assembly positioned within the stator housing and configured to generate electricity; and
a generator terminal block assembly positioned on an external surface of the stator housing, the generator terminal block assembly comprising multiple terminal pins, wherein the terminal pins are aligned with the terminal sockets in the frame.

9. The gas turbine engine of claim 8, wherein the terminal sockets each comprises a contact band configured to secure and electrically connect to the terminal pins.

10. The gas turbine engine of claim 8, wherein each of the terminal sockets comprise a feeder solder cup configured to secure and electrically connect electrical lines to transmit the electricity to one or more components of the gas turbine engine.

11. The gas turbine engine of claim 10, wherein the frame further comprises a feeder conduit configured to route the electrical lines through the frame without exposure to objects flowing though the frame.

12. The gas turbine engine of claim 8, wherein:
the generator further comprises an alignment pin positioned on the external surface of the stator housing;
the frame further comprises an alignment groove on an internal surface; and
the alignment pin is configured to align with the alignment groove in the frame.

13. The gas turbine engine of claim 12, wherein, when the stator housing is inserted into the frame, the alignment pin is inserted into the alignment groove prior to the terminal pins being inserted into the terminal sockets.

14. The gas turbine engine of claim 8, wherein the generator further comprises an input shaft configured to couple to a low-speed shaft of the gas turbine engine, the input shaft configured to rotate one or more components of the stator assembly to generate the electricity.

15. A method comprising:
aligning multiple terminal pins in a terminal block assembly positioned on an external surface of a stator housing with terminal sockets in a frame of a gas turbine engine;
inserting the stator housing into the frame of the gas turbine engine; and
generating electricity using a stator assembly positioned within the stator housing.

16. The method of claim 15, wherein the terminal pins extend radially from the stator assembly and axially along the external surface of the stator housing.

17. The method of claim 15, further comprising:
soldering a solder cup on each of the terminal pins to the stator assembly.

18. The method of claim 15, further comprising:
bolting a threaded insert on each of the terminal pins to the stator assembly.

19. The method of claim 15, further comprising:
aligning an alignment pin positioned on the external surface of the stator housing with an alignment groove in the frame of the gas turbine engine.

20. The method of claim 19, wherein inserting the stator housing into the frame of the gas turbine engine comprises inserting the alignment pin into the alignment groove prior to the terminal pins inserting into the terminal sockets.
